(19) United States
(12) Patent Application Publication
(10) Pub. No.: US 2017/0260930 A1
(43) Pub. Date: Sep. 14, 2017

(54) Leakage Diagnosis In A Fuel Tank System

(71) Applicant: Continental Automotive GmbH

(72) Inventors: Manfred Weigl, Sinzing (DE); Lamproula Charmpa, Regensburg (DE); Harry Schuele, Neunburg V. Wald (DE)

(73) Assignee: Continental Automotive GmbH, Hannover (DE)

(21) Appl. No.: 15/125,445

(22) PCT Filed: Aug. 7, 2015
(86) PCT No.: PCT/EP2015/068293

§ 371 Date: Sep. 12, 2016

(30) Foreign Application Priority Data
Aug. 28, 2014 (DE) 10 2014 217 195.4

(51) Int. Cl. F02M 25/08; G01M 3/02; G01M 3/26; B60K 15/035

(52) U.S. Cl. CPC F02M 25/0818; B60K 15/03504; F02M 25/0836; G01M 3/025; G01M 3/26; B60K 2015/0319

(57) ABSTRACT

The present disclosure relates to internal combustion engines and its teachings may be applied to methods for leakage diagnosis in a fuel tank system. A method for diagnosing leakage may include: closing a fresh air line and a hydrocarbon/air mixture line connected to the fuel tank; measuring a first pressure change in the fuel tank system over a predefined first time interval; opening the fresh air line; operating the purge air pump until a predefined excess pressure is reached; closing the fresh air line; measuring a second pressure change over a predefined second time interval; and comparing the pressure changes to diagnose a leakage in the fuel tank system.

### CROSS-REFERENCE TO RELATED APPLICATIONS

This application is a U.S. National Stage Application of International Application No. PCT/EP2015/068293 filed Aug. 7, 2015, which designates the United States of America, and claims priority to DE Application No. 10 2014 217 195.4 filed Aug. 28, 2014, the contents of which are hereby incorporated by reference in their entirety.

### TECHNICAL FIELD

The present disclosure relates to internal combustion engines and its teachings may be applied to methods for leakage diagnosis in a fuel tank system of an internal combustion engine of a motor vehicle.

### BACKGROUND

Numerous measures to reduce pollutant emissions stemming from motor vehicles have been introduced in recent decades. One of these measures is to use a fuel tank system in which a fuel tank is connected to a storage element for the temporary storage of hydrocarbons. When motor vehicles are being refueled with fuels based on hydrocarbons, hydrocarbons outgas from the fuel, but the hydrocarbons are not supposed to get into the atmosphere. There is increased outgassing of hydrocarbons from the fuel at high temperatures or during journeys over uneven surfaces as well, and effective measures must be taken to ensure that these hydrocarbons do not escape into the atmosphere. Particularly in the case of hybrid vehicles, in which the internal combustion engine is completely stationary for long distances, the outgassed hydrocarbons must be temporarily stored in an effective manner to enable them to be subsequently burnt when the internal combustion engine is restarted.

There are proven fuel tank systems for this purpose, comprising a fuel tank and a storage element for the temporary storage of hydrocarbons, wherein the fuel tank and the storage element are connected to one another in such a way that the hydrocarbons which outgas from a fuel in the fuel tank are stored in the storage element, wherein the storage element is connected to a fresh air line, through which fresh air can be conveyed to the storage element, and the storage element is connected to a hydrocarbon/air mixture line, which connects the storage element to an intake line of the internal combustion engine and through which fresh air enriched with hydrocarbons can be conveyed out of the storage element to the intake line.

In this way, the storage element can be purged cyclically with fresh air, and the stored hydrocarbons can be fed to an intake line which connects the internal combustion engine to the air filter and which supplies the internal combustion engine with air for combustion. This enables the hydrocarbons outgassed from the fuel tank to be burnt in the internal combustion engine, and the hydrocarbons are reliably prevented from escaping into the atmosphere. To convey the hydrocarbons out of the storage element to the intake line, a purge air pump may be employed, which can be designed as a radial pump, for example. To ensure fault-free operation of the fuel tank system, it is necessary to check the leaktightness of the entire fuel tank system at regular intervals. This leaktightness check cannot be restricted to visits to a garage by the motor vehicle; on the contrary, the leaktightness check must be carried out in the vehicle, i.e., on board, and at regular intervals over the entire life of the motor vehicle.

When the vehicle tank system is being checked, a number of physical effects are superimposed, and therefore checking for leaks is a challenging task. A temperature increase in the fuel tank and hence in the fuel leads to a considerable rise in the vapor pressure of the hydrocarbons. A pressure increase in the fuel tank system can likewise be triggered by driving over a very uneven surface and by the resulting shaking of the fuel. Cooling of the fuel, on the other hand, results in a pressure drop in the fuel tank system. All these pressure fluctuations occur in a fully intact fuel tank system simply by virtue of external influences.

In all cases, a leak in the fuel tank system causes a pressure drop, but the pressure fluctuations described above may be superimposed thereon. It is therefore very difficult to obtain reliable assessments of the freedom from leaks of a fuel tank system using only a pressure sensor.

### SUMMARY

The teachings of the present disclosure may enable a method for leakage diagnosis in a fuel tank system which allows reliable assessments to be made on the state of the fuel tank system.

In some embodiments, a method for leakage diagnosis in a fuel tank system (1) of an internal combustion engine (2) of a motor vehicle, wherein the fuel tank system (1) has a fuel tank (16) and a storage element (19) for the temporary storage of hydrocarbons (23), wherein the fuel tank (16) and the storage element (19) are connected to one another in such a way that the hydrocarbons (23) which outgas from a fuel (17) which is situated in the fuel tank (16) are stored temporarily in the storage element (19), wherein the storage element (19) can be emptied by means of a purge air pump (7), wherein fresh air (24) can be conveyed by means of the purge air pump (7) through a fresh air line (42) to the storage element (19), as a result of which the hydrocarbons (23) can be released from the storage element (19) and can be fed through a hydrocarbon/air mixture line (43) to the internal combustion engine (2) for combustion, wherein the fresh air line (42) can be closed by means of a first valve (10), and the hydrocarbon/air mixture line (43) can be closed by means of a second valve (15), and wherein a pressure sensor (8) is arranged in the fuel tank system (1), may include a stationary period of the motor vehicle is waited for in a first method step, the first valve (10) and the second valve (15) are closed in a second method step, the pressure change in the fuel tank system (1) is measured by means of the pressure sensor (8) within a predefined first time interval (T) in a third method step, the first valve (10) or the second valve (15) is opened, and an excess pressure is built up in the fuel tank system (1) by means of the purge air pump (7) until a predefined excess pressure is reached in a fourth method step, the valve (10, 15) which was opened in the fourth method step is closed again in a fifth method step, the pressure change in the fuel tank system (1) is measured by means of the pressure sensor (8) within a predefined second time interval (T) in a sixth method step, and the pressure changes which were measured in the third method step and in the sixth method step are compared with one another, and the results are derived from said comparison for leakage diagnosis, in a seventh method step.

In some embodiments, the duration of the first time interval is equal to that of the second time interval.

By virtue of the fact that a stationary period of the motor vehicle is waited for in a first method step, the first valve and the second valve are closed in a second method step, the pressure change in the fuel tank system is measured by means of the pressure sensor within a predefined first time interval in a third method step, the first valve or the second valve is opened, and an excess pressure is built up in the fuel tank system by means of the purge air pump until a predefined excess pressure is reached in a fourth method step, the valve which was opened in the fourth method step is closed again in a fifth method step, the pressure change in the fuel tank system is measured by means of the pressure sensor within a predefined second time interval in a sixth method step, and the pressure changes which were measured in the third method step and in the sixth method step are compared with one another, and the results for leakage diagnosis are derived from said comparison, in a seventh method step, a very accurate and reliable conclusion on the presence of a leak in the fuel tank system can be drawn.

### BRIEF DESCRIPTION OF THE DRAWINGS

Some embodiments of the present teachings are described with reference to the figures.

FIG. 1 shows an internal combustion engine having a fuel tank system,

FIG. 2 shows a pressure/time diagram.

### DETAILED DESCRIPTION

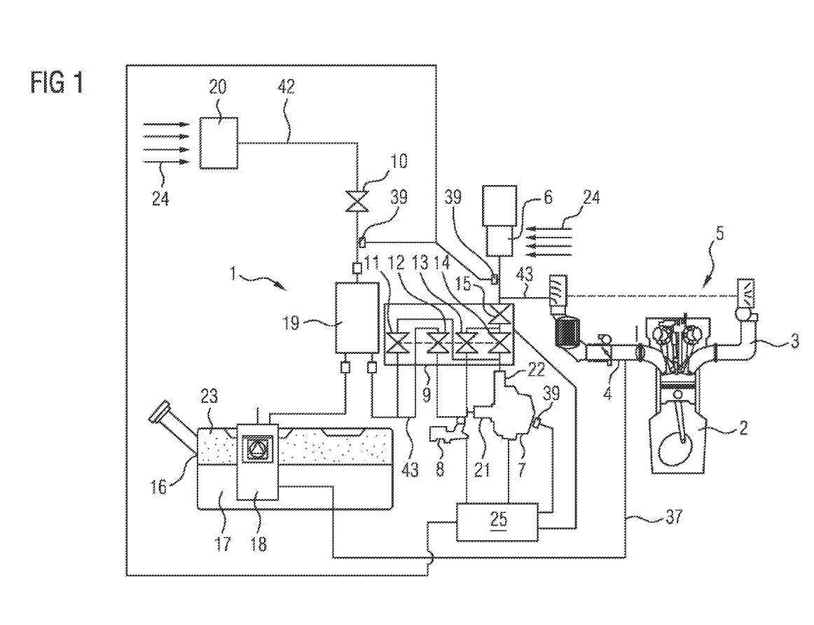

FIG. 1 shows an internal combustion engine 2 having a fuel tank system 1. The internal combustion engine 2 has an exhaust line 3 and an intake line 4. To recover the kinetic energy contained in the exhaust gas, the exhaust line is fitted with a turbocharger 5, which can compress the intake air in the intake line 4. The internal combustion engine 2 is supplied with fresh air 24 via the intake line 4. Starting from the fresh air side, fresh air 24 is passed via an air filter 6 into the intake line 4 and possibly compressed by means of the exhaust turbocharger 5 or a supercharger and then fed into the combustion chambers of the internal combustion engine 2. Fuel 17 from the fuel tank 16 is furthermore fed to the internal combustion engine 1 via a fuel line 37.

FIG. 1 furthermore shows the fuel tank system 1 with the fuel tank 16 and a storage element 19 for the temporary storage of hydrocarbons 23. The fuel tank 16 and the storage element 19 are connected to one another in such a way that the hydrocarbons 23 which outgas from a fuel 17 in the fuel tank 16 can be stored in the storage element 19. The storage element 19 can be designed as an activated carbon storage device, for example. An activated carbon storage device is a closed canister in which, generally granular, carbon is arranged in such a way that the hydrocarbons 23 to be stored collect on the carbon.

However, the storage element 19 has only a limited storage capacity, and therefore the storage element 19 must be emptied at regular intervals by drawing in fresh air 24, e.g. via a purge air filter 20, and sucking or forcing it into the storage element 19 via a fresh air line 42 with the aid of a purge air pump 7. The fresh air 24 flows through the activated carbon in the storage element 19 and, in the process, absorbs hydrocarbons 23, thereby increasing the hydrocarbon concentration in the fresh air 24 supplied, after which the fresh air 24 enriched with the hydrocarbons 23 is conveyed to the intake line 4 along a hydrocarbon/air mixture line 43.

In the intake line 4, the fresh air 24 enriched with the hydrocarbons 23 mixes with the fresh air 24 drawn in via the air filter 6. The hydrocarbons 23 can thus be fed to the internal combustion engine 1, where the hydrocarbons 23 are burnt in the combustion chambers of the internal combustion engine 2. Since the fuel tank system 1 contains highly volatile hydrocarbons 24, it is necessary at regular intervals to check the leaktightness or freedom from leaks of the entire fuel tank system 1.

One component of the fuel tank system 1 shown in FIG. 1 is the valve unit 9. In this example, the valve unit 9 comprises a fifth valve 11, a sixth valve 12, a third valve 13, a fourth valve 14 and a second valve 15. Together with a first valve 10, the second valve 15 serves to completely seal off the fuel tank system 1. Thus, when the second valve 15 and the first valve 10 are closed and there is no leak in the fuel tank system 1, the pressure present in the fuel tank system 1 after the closure of the second valve 15 and of the first valve 10 is maintained at a constant level as long as there are no further external influences on the fuel tank system 1, such as temperature changes or mechanical shocks.

This constant pressure P can be detected by the pressure sensor 8 and monitored by means of the control unit 25. However, when there is a temperature change in the fuel 17, for example, due to the waste heat from the fuel delivery unit 18, for example, the pressure P in the fuel tank system 1 will change. This pressure change in the fuel tank system 1 is measured by means of the pressure sensor 8 within a predetermined first time interval T, wherein the measured results can be processed and stored in a control unit 25, for example.

In a fourth method step, the second valve 15 (or the first valve 10, depending on where the purge air pump 7 is positioned) is opened, and an excess pressure is built up in the fuel tank system 1 by means of the purge air pump 7 until a predetermined excess pressure is reached. Here, the fifth valve 11, the sixth valve 12, the third valve 13 and the fourth valve 14, which are components of the valve unit 9, serve to reverse the delivery direction of the fresh air 24, thereby allowing fresh air 24 to be conveyed into the fuel tank 16 by the purge air pump 7.

To purge the storage element 19, the first valve 10 is opened, and the sixth valve 12 and the fourth valve 14 as well as the second valve 15 in the valve unit 9 are opened. The fifth valve 11 in the valve unit 9 and the third valve 13 in the valve unit 9 are closed. If the purge air pump 7, which is designed as a radial pump and can thus only deliver the medium to be pumped from the suction side 21 to the pressure side 22, is then operated, fresh air is fed from the purge air filter 20, via the first valve 10 and through the storage element 19, to the intake line 4 of the internal combustion engine 2.

In this configuration, the storage element 19, which can be designed as an activated carbon filter, is thus purged with fresh air 24, wherein the hydrocarbons 23 stored in the storage element 19 are purged and fed to the internal combustion engine 2. When there is no need to purge the storage element 19 because, for example, it is laden with only a small quantity of hydrocarbons 23, i.e. there is only a low hydrocarbon concentration in the storage element 19, the first valve 10 can be closed. Moreover, the sixth valve 12 and the fourth valve 14 in the valve unit 9 can also be closed. Initially, the second valve 15 remains open. If the purge air pump 7 is then operated, fresh air 24 is drawn in via the air filter 6 and forced in the direction of the storage element 19 and of the fuel tank 17. A controlled pressure increase in the fuel tank system 1 therefore takes place.

The pressure increase in the fuel tank system 1 can be monitored by means of the pressure sensor 8 and/or the speed or power consumption of the purge air pump 7. For this purpose, both the pressure sensor 8 and the purge air pump 7 are connected to an electronic control unit 25. Control of all the valves 10, 11, 12, 13, 14, 15 mentioned can also be accomplished by means of the control unit 25. Moreover, at least one temperature sensor 39 can be connected to the control unit 25. If the fuel tank system 1 is then supplied with a predetermined pressure, the second valve 15 can be shut off, thereby ensuring that the pressure built up in the fuel tank system 1 is maintained as long as there is no leak in the fuel tank system 1. With the fuel tank system 1 described here, the leaktightness of the fuel tank system 1 can be checked at regular intervals during normal operation of a motor vehicle, this being an important requirement flowing from the regulations relating to protection of the environment and the atmosphere.

In some embodiments, the pressure change in the fuel tank system 1 is measured by means of the pressure sensor 8 within a predefined second time interval T, and the pressure changes which were measured in the third method step and in the sixth method step are compared with one another, and the results are derived from said comparison for leakage diagnosis, in a seventh method step.

With the aid of the temperature sensors 39, which can be arranged at different points in the fuel tank system 1, it is possible to establish a link between the pressure produced by the radial pump and the speed at which it is driven or the power which it consumes. The excess pressure produced in the fuel tank system 1 can thereby be well monitored by the control unit 25 by means of the power consumption or speed of the radial pump 7, and a qualitatively high-grade leakage diagnosis can be accomplished.

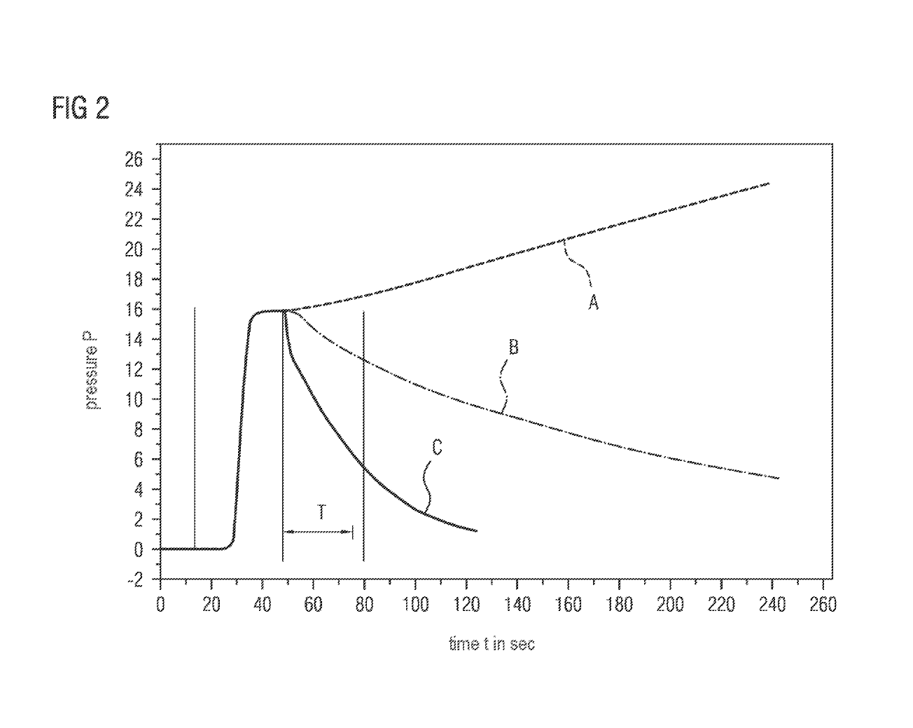

FIG. 2 shows a pressure/time diagram. The relative pressure P is plotted on the ordinate of the coordinate system, and the time t is plotted in seconds on the abscissa of the coordinate system. Curve A shows the relative pressure in the fuel tank system 1 measured by means of the pressure sensor 8. Curve A is the measured result for a completely leak-free fuel tank system 1. For example, a temperature increase in the fuel 17, which may be caused by the waste heat of the fuel delivery unit 18, produces a pressure rise in the hermetically sealed fuel tank system 1. This pressure rise takes place in a largely linear manner, this being clearly visible in curve A.

Curve B shows a pressure drop which, starting from a time of approximately 50 seconds, has the shape of a falling exponential function. This behavior indicates a small leak of the order of about 0.1 to 0.5 mm diameter in the fuel tank system 1.

Curve C shows a sharp pressure drop from a time of about 50 seconds, this likewise having a negative exponential profile and indicating a relatively large leak in the fuel tank system 1. In the case of such a sharp pressure drop, there is a leak of at least 1 mm diameter in the fuel tank system 1.

Since, in reality, effects such as the presence of a small leak in the fuel tank system 1 (curve B) and a pressure rise due to waste heat (curve A) are often superimposed, it is difficult to detect a leak only on the basis of a single pressure measurement. However, the method according to the invention makes it possible to obtain a reliable assessment of the presence of a leak by measuring the pressure change in the third and in the sixth method step and then comparing the measured results, i.e. the pressure/time diagrams obtained, and even to determine approximately the size of the leak.

What is claimed is:

1. A method for diagnosing leakage in a fuel tank system of an internal combustion engine of a motor vehicle, the fuel tank system including a storage element for temporary storage of hydrocarbons outgassing from a fuel present in a fuel tank, the method comprising:
detecting a stationary period of the motor vehicle;
isolating the storage element from a combustion chamber of the internal combustion engine;
measuring a first pressure change in the fuel tank system over a predefined first time interval;
pressurizing the storage element to a predetermined pressure;
measuring a second pressure change in the fuel tank system over a predefined second time interval; and
comparing the first pressure change and the second pressure change to diagnose a leakage in the fuel tank system.

2. The method as claimed in claim 1, wherein the first time interval is equal to the second time interval.

3. The method as claimed in claim 1, wherein isolating the storage element from a combustion chamber of the internal combustion engine comprises closing a fresh air line with first valve.

4. The method as claimed in claim 1, wherein isolating the storage element from a combustion chamber of the internal combustion engine comprises closing a hydrocarbon/air mixture line with a second valve.

5. The method as claimed in claim 1, wherein isolating the storage element from a combustion chamber of the internal combustion engine comprises closing a fresh air line with a first valve and a hydrocarbon/air mixture line with a second valve, wherein the fresh air line brings fresh air to a storage element through a purge air pump and the hydrocarbon/air mixture line brings hydrocarbons and air from the storage element to a combustion chamber of the internal combustion engine.

6. The method as claimed in claim 1, wherein pressurizing the storage element to a predetermined pressure comprises:
opening one of the first valve and the second valve;
operating the purge air pump until a predefined excess pressure is reached in the fuel tank system; and
closing the valve that was opened.

7. A fuel storage system for an internal combustion engine, the fuel storage system comprising:
a fuel tank for storing a fuel;
an additional storage element in fluid communication with the fuel tank, the storage element capturing hydrocarbons that evaporate from the fuel;
a purge air pump supplying fresh air to the storage element;
a pressure sensor detecting a pressure in the storage element; and
a controller operable to:
detect an inactive period of the internal combustion engine;
isolate the storage element from a combustion chamber of the internal combustion engine;
receive a signal corresponding to a first pressure change in the storage element over a predefined first time interval;
activate the purge air pump to pressurize the storage element to a predetermined pressure;
receive a second signal corresponding to a second pressure change in the storage element over a predefined second time interval; and
compare the first pressure change and the second pressure change to diagnose a leakage in the fuel tank system.
